(19) United States
(12) Patent Application Publication
(10) Pub. No.: US 2016/0041039 A1
(43) Pub. Date: Feb. 11, 2016

(54) SENSOR CALIBRATION METHOD, COMPUTER PROGRAM AND COMPUTER READABLE MEDIUM

(71) Applicant: FLIR SYSTEMS AB, Täby (SE)

(72) Inventor: Stefan OLSSON, Stockholm (SE)

(73) Assignee: Flir Systems AB

(21) Appl. No.: 14/653,842

(22) PCT Filed: Dec. 16, 2013
(86) PCT No.: PCT/SE2013/000195

§ 371 Date: Jun. 18, 2015

(30) Foreign Application Priority Data
Dec. 18, 2012 (SE) 1230150-3

(51) Int. Cl. G01J 5/10; H04N 5/33

(52) U.S. Cl. CPC G01J 5/10; H04N 5/33; G01J 2005/0048

(57) ABSTRACT

The invention relates to a method for the calibration of sensors of the type that comprises a plurality of sensor elements, such as focal plane arrays, FPAs, for detecting infrared radiation, IR-FPA, the calibration being performed at least two temperatures. According to the invention, the sensor's dynamic range is divided into a plurality of intervals (5), a correction map is updated on a miming basis in each interval by a scene-based non-uniformity correction (6), the correction terms between adjacent intervals are interpolated (7), and the interpolated correction terms are made to correct the sensor elements of the relevant sensor (8). The invention also relates to a computer program and a computer program product. By way of the invention, a method is provided which effectively minimizes the fixed pattern noise to near zero across the entire dynamic range of the sensor, regardless of the type of non-linearity.

### FIELD OF THE INVENTION

The present invention relates to a method for the calibration of sensors of the type that comprises a plurality of sensor elements, such as focal plane arrays, FPAs, for detecting infrared radiation, IR-FPA, the calibration being performed at at least two temperatures. The invention also relates to a computer program comprising program code, which, when said program code is executed on a computer, causes said computer to perform the method, as well as a computer program product comprising a computer readable medium and a computer program according to the above, said computer program being comprised in said computer readable medium.

### BACKGROUND

The output signal from the sensor elements of a sensor, such as an IR-FPA, can vary quite considerably as a function of incident power. The sensor elements therefore need to be calibrated between themselves. For example, the sensor elements included in a sensor of an IR camera do not behave the same way, but exhibit variations in gain and offset. To handle these variations, so-called gain and offset maps are included and stored in production. The gain map is used during operation to correct for gain variations in the individual sensor elements of a sensor. Correspondingly, the offset map is used during operation to parallel offset the sensor signals of the included sensor elements so that the gain curves of the detectors substantially coincide. To further elucidate the principles behind gain and offset mapping, reference is made to our published U.S. patent application US 2011/0164139 A1.

A common way to calibrate the sensor of a camera is to let the camera watch perfectly flat black body radiators at different temperatures. In case the non-linearity between the different sensor elements is the same, with variations only in gain and offset level, it is sufficient to calibrate the sensor against two different temperatures, so-called two-point correction. In many cases, however, this requirement for non-linearity between sensor elements is not met, especially in extreme temperatures or when sensors with poor uniformity are used. One solution has then been to calibrate against black body radiators at several temperatures. To cover the entire dynamic range, the response of each individual detector element must be measured across the entire dynamic range. Such a solution, however, has several disadvantages. Among other things, the solution is tedious and requires unreasonably long time during production. Also, the solution requires large memory capacity.

### SUMMARY OF THE INVENTION

The purpose of the present invention is to provide a method that corrects for gain and offset, and the difference in non-linearity, thereby effectively minimizing fixed pattern noise without tedious measurement of individual detector elements during production.

The purpose of the invention is achieved by a method characterized in that the sensor's dynamic range is divided into a plurality of intervals with respect to temperature, that a correction map is updated on a running basis in each interval by a scene-based non-uniformity correction, that the correction terms between adjacent intervals are interpolated, and that the interpolated correction terms are made to correct the sensor elements of the relevant sensor.

By way of the proposed method, an effective minimization of the fixed pattern noise to near zero across the sensor's entire dynamic range is achieved, without doing it the traditional way, where the response of each detector element must be measured across the entire dynamic range, the latter of which can be extremely tedious. Moreover, the method is independent of the type of non-linearity exhibited by the detector elements.

According to a proposed suitable method, the sensor's dynamic range is divided into at least three intervals.

According to another proposed suitable method, the number of intervals that the dynamic range is divided into is increased if greater accuracy of the calibration is required.

According to a further proposed suitable method, the correction map is updated on a running basis in the middle of each interval.

According to yet another proposed suitable method, the scene-based non-uniformity correction consists of a scene-based corrective algorithm.

Furthermore, according to a suitable method, it is proposed that the sensor elements of a focal plane array are calibrated.

### BRIEF DESCRIPTION OF THE DRAWING

The invention will be further described below by way of example with reference to the accompanying drawing wherein:

FIG. 1 schematically shows an IR sensor with a plurality of sensor elements.

FIG. 2 shows examples of the gain of some sensor elements included in an IR sensor as a function of temperature.

FIG. 3 shows a schematic flowchart illustrating the principles behind the invention.

### DETAILED DESCRIPTION OF THE EMBODIMENT

The IR sensor 1 showed in FIG. 1 comprises m x n sensor elements S_{1,1}-S_{m,n}, distributed across m rows and n columns. The sensor can consist of a focal plane array, IR-FPA. Each individual sensor element S_{1,1}-S_{m,n} included in the sensor 1 can have its own gain curve.

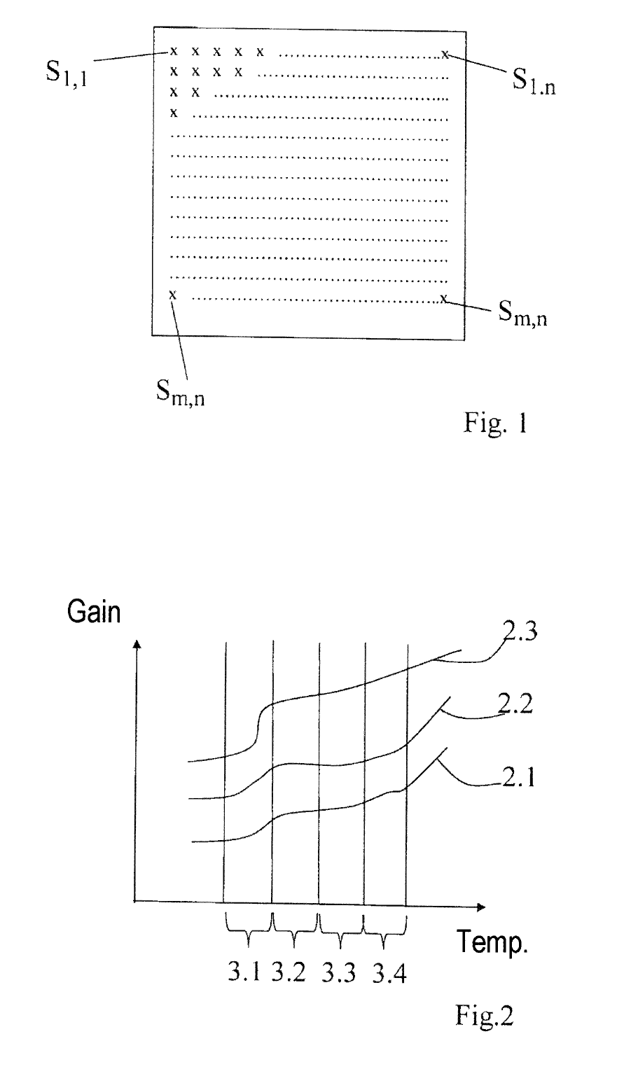

FIG. 2 shows examples of some gain curves 2.1, 2.2 and 2.3 as a function of the temperature T. As shown in the figure, the individual gain curves can exhibit very different curve shapes. Vertical lines divide the sensor's dynamic range into intervals. In FIG. 2 four ranges 3.1-3.4 have been marked. In case the sensor elements have very different shapes, an even more extensive division of the sensor's dynamic range into intervals is required than if the curve shapes of the sensors are similar.

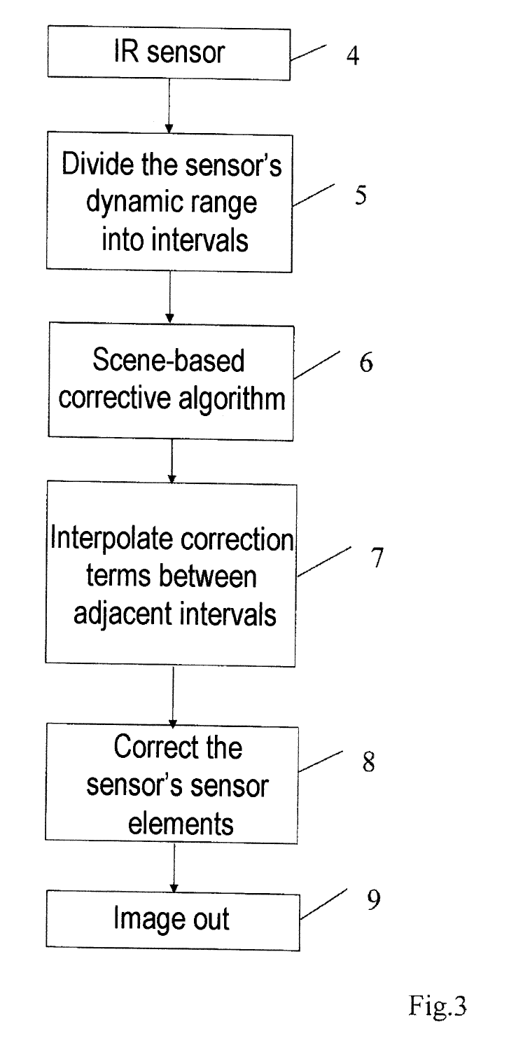

The principles behind the invention will be explained below with reference to the schematic flowchart shown in FIG. 3.

An IR sensor included in Block 4 delivers an image to Block 5. In Block 5 the sensor's dynamic range is divided into intervals 3.1, 3.2, 3.3, etc. In the middle of each interval, a correction map created by some kind of scene-based corrective algorithm of known type is updated on a running basis according to Block 6. Then, in Block 7, the correction terms are interpolated between adjacent intervals. The obtained interpolated correction terms correct the sensor elements with respect to both gain and offset, and for differences in non-linearity, which is performed in Block 8 by letting the interpolated correction terms correct the sensor elements of the relevant sensor using the obtained interpolated correction terms for the current temperature range so that a corrected image can be delivered, Block 9. The accuracy of the non-linearity correction depends on the number of intervals; several short intervals means greater accuracy. Theoretically, using an infinite number of small intervals, the method can manage an arbitrary variation between the sensor elements.

The invention is not restricted to the exemplary method described above, but can be subject to modifications within the scope of the appended claims.

1. A method for calibrating a sensor comprising a plurality of sensor elements configured to detect infrared radiation at at least two temperatures, the method comprising:
dividing the sensor's dynamic range into a plurality of intervals with respect to temperature;
updating a correction map on a running basis in each interval by a scene-based non-uniformity correction;
interpolating correction terms of adjacent intervals; and
correcting the sensor elements of the sensor using the interpolated correction terms.

2. The method according to claim 1, wherein the dividing of the sensor's dynamic range into a plurality of intervals comprises dividing the sensor's dynamic range into at least three intervals.

3. The method according to claim 1, wherein the number of intervals that the dynamic range is divided into is increased if greater accuracy of the calibration is required.

4. The method according to claim 1, wherein the updating of the correction map comprises updating the correction map in the middle of each interval.

5. The method according to claim 1, wherein the scene-based non-uniformity correction comprises a scene-based corrective algorithm.

6. The method according to claim 1, wherein the calibrating of the sensor comprises calibrating the sensor elements (S_{1,1}-S_{m, n}) of the sensor.

7. (canceled)

8. (canceled)

9. The method according to claim 1, wherein the sensor comprises a focal plane array configured to detect infrared radiation (IR-FPA).

10. The method according to claim 1, wherein the correcting of the sensor elements of the sensor using the interpolated correction terms comprises correcting the sensor elements with respect to gain and offset.

11. The method according to claim 1, wherein the correcting of the sensor elements of the sensor using the interpolated correction terms comprises correcting the sensor elements for differences in non-linearity.

12. An infrared camera comprising a sensor having a plurality of sensor elements configured to detect infrared radiation at at least two temperatures, the infrared camera being configured to perform the method of claim 1.

13. The infrared camera according to claim 12, wherein the sensor comprises a focal plane array of the sensor elements configured to detect infrared radiation (IR-FPA).

14. A non-transitory computer-readable medium encoded with executable instructions which, when executed by a computer, causes the computer to perform a method for calibrating a sensor that comprises a plurality of sensor elements configured to detect infrared radiation at at least two temperatures, the method comprising:
dividing the sensor's dynamic range into a plurality of intervals with respect to temperature;
updating a correction map on a running basis in each interval by a scene-based non-uniformity correction;
interpolating correction terms between adjacent intervals; and
correcting the sensor elements of the sensor using the interpolated correction terms.

15. The non-transitory computer-readable medium according to claim 14, wherein the dividing of the sensor's dynamic range into a plurality of intervals comprises dividing the sensor's dynamic range into at least three intervals.

16. The non-transitory computer-readable medium according to claim 14, wherein the number of intervals that the dynamic range is divided into is increased if greater accuracy of the calibration is required.

17. The non-transitory computer-readable medium according to claim 14, wherein the updating of the correction map comprises updating the correction map in the middle of each interval.

18. The non-transitory computer-readable medium according to claim 14, wherein the scene-based non-uniformity correction comprises a scene-based corrective algorithm.

19. The non-transitory computer-readable medium according to claim 14, wherein the calibrating of the sensor comprises calibrating the sensor elements (S_{1,1}-S_{m,n}) of the sensor.

20. The non-transitory computer-readable medium according to claim 14, wherein the sensor comprises a focal plane array configured to detect infrared radiation (IR-FPA).

21. The non-transitory computer-readable medium according to claim 14, wherein the correcting of the sensor elements of the sensor using the interpolated correction terms comprises correcting the sensor elements with respect to gain and offset.

22. The non-transitory computer-readable medium according to claim 14, wherein the correcting of the sensor elements of the sensor using the interpolated correction terms comprises correcting the sensor elements for differences in non-linearity.
